(19) United States
(12) Patent Application Publication
(10) Pub. No.: US 2015/0076914 A1
(43) Pub. Date: Mar. 19, 2015

(54) POWER CONVERSION SYSTEM AND ELECTRONIC DEVICE USING SAME

(71) Applicant: HON HAI PRECISION INDUSTRY CO., LTD., New Taipei (TW)

(72) Inventor: YU-CHI TSAI, New Taipei (TW)

(73) Assignee: HON HAI PRECISION INDUSTRY CO., LTD., New Taipei (TW)

(21) Appl. No.: 14/092,904

(22) Filed: Nov. 27, 2013

(30) Foreign Application Priority Data
Sep. 13, 2013 (TW) 102133108

(51) Int. Cl. H02J 9/04

(52) U.S. Cl. CPC H02J 9/04
USPC 307/66

(57) ABSTRACT

A power conversion system includes a power distribution unit and a first alternating current (AC) power supply unit (PSU) connected to the power distribution unit. The power distribution unit selectively transmits either an AC voltage of an AC power source or a first DC voltage of a direct current (DC) power source based on whether the AC voltage is supplied to the power distribution unit. The first AC PSU receives the AC voltage or the first DC voltage based on which one of the AC voltage and the first DC voltage is outputted from the power distribution unit, converts the AC voltage or the first DC voltage into a second DC voltage, and outputs the second DC voltage to a load.

### BACKGROUND

1. Technical Field

The present disclosure relates to a power conversion system and an electronic device using the power conversion system.

2. Description of Related Art

Electronic devices, such as servers, usually employ an alternating current power supply unit (AC PSU) and a direct current power supply unit (DC PSU) connected to the AC PSU in parallel. When an AC power source supplies AC voltage to the electronic device, the AC PSU converts the AC voltage from the AC power source into a predetermined DC voltage, and outputs the predetermined DC voltage to a load of the electronic device. The DC PSU is in a standby mode when the AC power source normally supplies the AC voltage to the electronic device. The DC PSU receives a DC voltage from a DC power source and converts the DC voltage into the predetermined DC voltage, but does not output the predetermined DC voltage to the load when the DC PSU is in the standby mode.

When the AC power source is cut off from supplying the AC voltage to the AC PSU, the DC PSU switches to an operating mode and outputs the predetermined DC voltage to the load. However, because the AC power source normally supplies the AC voltage to the AC PSU, power is wasted keeping the DC PSU in the standby mode.

Therefore, what is needed is a power conversion system and an electronic device that can overcome the described limitations.

### BRIEF DESCRIPTION OF THE DRAWINGS

FIG. 1 is a schematic structural diagram illustrating a first embodiment of an electronic device according to the present disclosure.

FIG. 2 is a schematic structural diagram illustrating a second embodiment of an electronic device according to the present disclosure.

### DETAILED DESCRIPTION

Reference will now be made to the drawings to describe specific exemplary embodiments of the present disclosure.

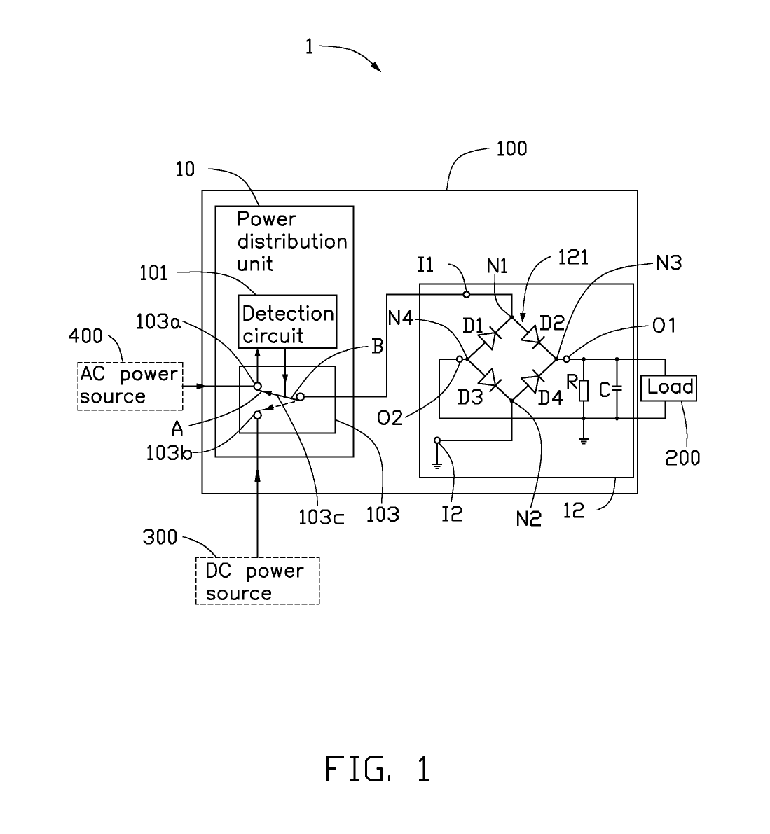

FIG. 1 is a schematic structural diagram illustrating a first embodiment of an electronic device 1. The electronic device 1 includes a power conversion system 100 and a load 200 connected to the power conversion system 100. The power conversion system 100 is configured to connect to a direct current (DC) power source 300 and an alternating current (AC) power source 400. The DC power source 300 is configured to supply a first DC voltage to the power conversion system 100. The AC power source 400 is configured to supply AC voltage to the power conversion system 100. The power conversion system 100 selectively converts either the first DC voltage or the AC voltage into a second DC voltage based on whether the AC power source 400 supplies the AC voltage to the power conversion system 100, and outputs the second DC voltage to the load 200. The load 200 operates based on the second DC voltage. The load 200 can be a server, a data center, or a storage, for example. The DC power source 300 can be a plurality of batteries connected in parallel, for example.

The power conversion system 100 converts the AC voltage into the second DC voltage when the AC power source 400 supplies the AC voltage to the power conversion system 100, even though the DC power source 300 simultaneously supplies the first DC voltage to the power conversion system 100. The power conversion system 100 converts the first DC voltage into the second DC voltage when the AC power source 400 is cut off from supplying the AC voltage to the power conversion system 100. A range of each of the AC voltage and the first DC voltage can be from about 90 volts (V) to about 264 V. A range of the second DC voltage can be from about 127V to about 375V, in one example.

The power conversion system 100 includes a power distribution unit 10 and a first AC power supply unit (PSU) 12 connected between the power distribution unit 10 and the load 200. The power distribution unit 10 selectively electrically connects the AC power source 400 or the DC power source 300 to the first AC PSU 12 based on whether the AC power source 400 supplies the AC voltage to the power distribution unit 10, and transmits the AC voltage or the first DC voltage to the first AC PSU 12. The first AC PSU 12 receives the AC voltage or the first DC voltage, converts the AC voltage or the first DC voltage into the second DC voltage, and outputs the second DC voltage to the load 200.

The power distribution unit 10 includes a detection circuit 101 and a selection circuit 103. The selection circuit 103 is connected to the detection circuit 101, the first AC PSU 12, the DC power source 300, and the AC power source 400. The detection circuit 101 detects whether the AC voltage is supplied to the selection circuit 103 and outputs corresponding control signals to the selection circuit 103 based on the detected AC voltage. The selection circuit 103 selectively outputs the AC voltage or the first DC voltage to the first AC PSU 12 based on the corresponding control signals. The corresponding control signals can include a first control signal and a second control signal. The first and second control signals can be digital signals, for example.

When the detection circuit 101 detects that the AC voltage is supplied to the selection circuit 103, the detection circuit 101 outputs the first control signal to the selection circuit 103. The selection circuit 103 receives the first control signal, selectively electrically connects the AC power source 400 to the first AC PSU 12 based on the first control signal, and transmits the AC voltage to the first AC PSU 12. In contrast, when the detection circuit 101 detects that the AC voltage is not supplied to the selection circuit 103, the detection circuit 101 outputs the second control signal to the selection circuit 103. The selection circuit 103 receives the second control signal, selectively electrically connects the DC power source 300 to the first AC PSU 12 based on the second control signal, and transmits the DC voltage to the first AC PSU 12.

The selection circuit 103 includes a first input 103a, a second input 103b, and a conductive pole 103c. The conductive pole 103c includes a first end A and a second end B. The first input 103a is connected to the AC power source 400 and receives the AC voltage. The second input 103b is connected to the DC power source 300 and receives the first DC voltage. The first end A is selectively connected to either the first input 103a or the second input 103b based on which one of the first and second control signals is received from the detection circuit 101. The second end B is connected to the first AC PSU 12. The detection circuit 101 detects whether the AC voltage is supplied to the first input 103a and controls whether the first end A is electrically connected to the first input 103a or the second input 103b based on the detection.

When the detection circuit 101 detects that the AC voltage is supplied to the first input 103a, the detection circuit 101 outputs the first control signal to the selection circuit 103. The selection circuit 103 controls the conductive pole 103c to electrically connect to the first input 103a (shown as a solid arrow in FIG. 1) based on the first control signal. The AC voltage is output to the first AC PSU 12 via the first input 103a and the conductive pole 103c. In contrast, when the detection circuit 101 detects that the AC voltage is not supplied to the first input 103a, the detection circuit 101 outputs the second control signal to the selection circuit 103. The selection circuit 103 controls the conductive pole 103c to electrically connect to the second input 103b (shown as a dashed arrow in FIG. 1). The first DC voltage is output to the first AC PSU 12 via the second input 103b and the conductive pole 103c based on the second control signal.

The first AC PSU 12 includes a full-bridge rectification circuit 121, a resistor R, and a capacitor C. The full-bridge rectification circuit 121 includes a first input I1, a second input 12, a first output O1, and a second output O2. The resistor R and the capacitor C are connected between the first output O1 and the second output O2 in parallel. The first input I1 is connected to the second end B of the conductive pole 103c to receive the AC voltage or the first DC voltage. The second input 12 is connected to ground. The first output O1 is connected to the load 200. The second output O2 is connected to ground.

The full-bridge rectification circuit 121 includes a first diode D1, a second diode D2, a third diode D3, and a fourth diode D4. A cathode of the first diode D1 is connected to an anode of the second diode D2. A first node N1 is defined between the first diode D1 and the second diode D2. The first node N1 is connected to the first input I1. A cathode of the third diode D3 is connected to an anode of the fourth diode D4. A second node N2 is defined between the third diode D3 and the fourth diode D4. The second node N2 is connected to the second input 12. A cathode of the second diode D2 is connected to an anode of the fourth diode D4. A third node N3 is defined between the second diode D2 and the fourth diode D4. The third node N3 is connected to the first output O1. An anode of the first diode D1 is connected to an anode of the third diode D3. A fourth node N4 is defined between the first diode D1 and the third diode D3. The fourth node N4 is connected to the second output O2.

The full-bridge rectification circuit 121 receives the AC voltage or the first DC voltage, converts the AC voltage or first DC voltage into the second DC voltage, and outputs the second DC voltage to the load 200. A capacitance of the capacitor C can be about 4700 microfarads (uF), for example.

Since the power conversion system 100 detects whether the AC voltage is inputted, the power conversion system 100 selectively outputs the AC voltage or the first DC voltage to the first AC PSU 12 based on the detection. Accordingly, the first AC PSU 12 converts the AC voltage or the first DC voltage into the second DC voltage and outputs the second DC voltage to the load 200. Thus, the power conversion system 100 need not employ a separate DC PSU as required in the prior art, and the first AC PSU 12 remains in an operating state whether the AC power source 400 is cut off or not. As a result, efficiency of supplying power to the load 200 is improved.

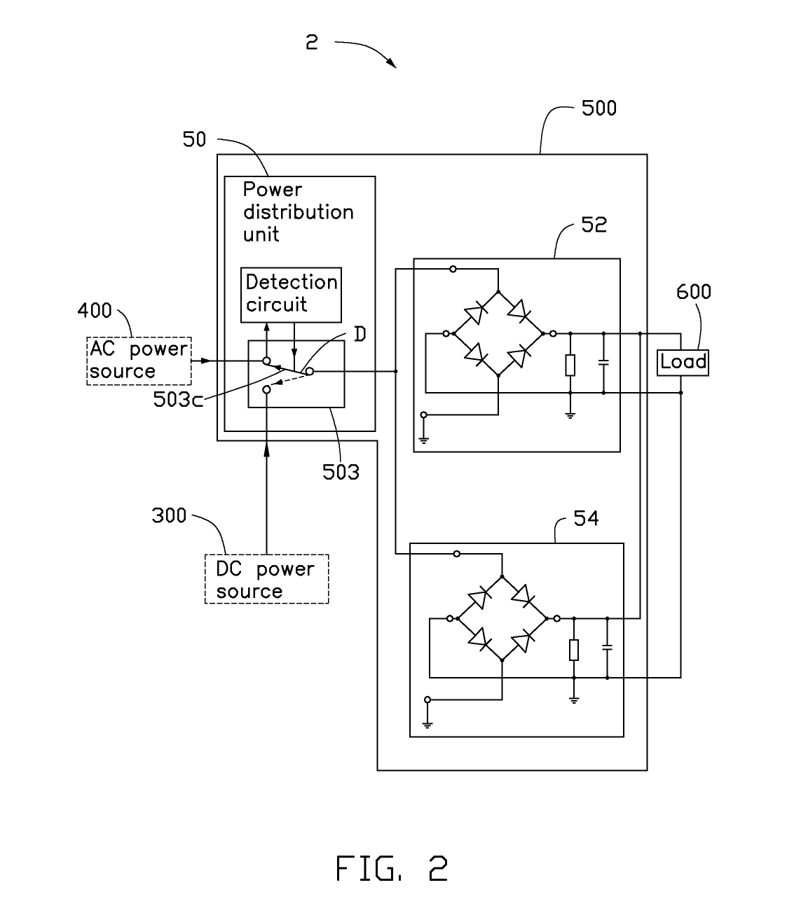

FIG. 2 is a schematic structural diagram illustrating a second embodiment of an electronic device 2. The electronic device 2 includes a power conversion system 500 and a load 600 connected to the power conversion system 500. The electronic device 2 differs from the electronic device 1 of the first embodiment in that the power conversion system 500 differs from the power conversion system 100 of the electronic device 1. The load 600 can be identical with the load 200 of the electronic device 1.

The power conversion system 500 includes a power distribution unit 50, a first AC PSU 52, and at least one second AC PSU 54. A number of the second AC PSU 54 can be N+1, wherein N is an integer more than one. The first AC PSU 52 and the at least one second AC PSU 54 are connected between the power distribution unit 50 and the load 600 in parallel. The first AC PSU 52 is substantially identical to the first AC PSU 12 of the power conversion system 100. In the embodiment, the at least one second AC PSU 54 can be identical to the first AC PSU 52. The second AC PSU 54 is connected between a second end D of a conductive pole 503c of a selection circuit 503 and the load 600.

The power distribution unit 50 selectively outputs the AC voltage from the AC power source 400 or the first DC voltage from the DC power source 300 to the first AC PSU 52 and the second AC PSU 54, based on whether the AC power source 400 supplies the AC voltage to the power distribution unit 50. The first AC PSU 52 and the second AC PSU 54 receive the AC voltage from the AC power source 400 or the first DC voltage from the DC power source 300, convert the AC voltage or the first DC voltage into the second DC voltage, and output the second DC voltage to the load 600.

Since the power conversion system 500 further includes the second AC PSU 54 connected to the first AC PSU 52 in parallel, an amount of current passing through the first AC PSU 52 is reduced. Accordingly, power consumed by the first AC PSU 52 is reduced. As a result, the first AC PSU 52 generates less heat.

It is believed that the present embodiments and their advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A power conversion system, comprising:
a power distribution unit connected to an AC power source and a direct current (DC) power source; and
a first alternating current (AC) power supply unit (PSU) connected to the power distribution unit, the power distribution unit selectively transmitting either an AC voltage of the AC power source or a first DC voltage of the DC power source to the first AC PSU based on whether the AC voltage is supplied to the power distribution unit; the first AC PSU receiving the AC voltage or the first DC voltage, converting the AC voltage or the first DC voltage into a second DC voltage, and outputting the second DC voltage to a load.

2. The power conversion system of claim 1, wherein the power distribution unit selectively outputs the AC voltage to the first AC PSU when the AC voltage is supplied to the power distribution unit; the first AC PSU correspondingly receives the AC voltage, converts the AC voltage into the second DC voltage, and outputs the second DC voltage to the load.

3. The power conversion system of claim 2, wherein the power distribution unit selectively outputs the first DC voltage to the first AC PSU when the AC voltage is not supplied to the power distribution unit; the first AC PSU correspondingly receives the first DC voltage, converts the first DC voltage into the second DC voltage, and outputs the second DC voltage to the load.

4. The power conversion system of claim 3, wherein the power distribution unit comprises a detection circuit and a selection circuit; the selection circuit is connected to the detection circuit, the first AC PSU, the AC power source, and the DC power source; the detection circuit detects whether the AC voltage is supplied to the selection circuit, and outputs a first control signal or a second control signal to the selection circuit based on the detection; the selection circuit selectively transmits one of the AC voltage and the first DC voltage to the first AC PSU based on which one of the first control signal and the second control signal is received from the detection circuit.

5. The power conversion system of claim 4, wherein when the detection circuit detects that the AC voltage is supplied to the selection circuit, the detection circuit outputs the first control signal to the selection circuit; the selection circuit selectively transmits the AC voltage to the first AC PSU based on the first control signal; when the detection circuit detects that the AC voltage is not supplied to the selection circuit, the detection circuit outputs the second control signal to the selection circuit; the selection circuit selectively transmits the first DC voltage to the first AC PSU based on the second control signal.

6. The power conversion system of claim 5, wherein the selection circuit comprises a first input, a second input, and a conductive pole; the conductive pole comprises a first end and a second end; the first input is connected to the AC power source and receives the AC voltage; the second input is connected to the DC power source and receives the first DC voltage; the first end is selectively connected to one of the first input and the second input based on which one of the first control signal and the second control signal is received from the detection circuit; the second end is connected to the first AC PSU.

7. The power conversion system of claim 5, wherein the first AC PSU comprises a full-bridge rectification circuit, a resistor, and a capacitor; the full-bridge rectification circuit comprises a first input, a second input, a first output, and a second output; the resistor and the capacitor are connected between the first output and the second output in parallel; the first input is connected to the second end of the conductive pole, and receives the AC voltage or the first DC voltage; the second input is connected to ground; the first output is connected to the load; the second output is connected to ground; the full-bridge rectification circuit receives the AC voltage or the first DC voltage, converts the AC voltage or first DC voltage into the second DC voltage, and outputs the second DC voltage to the load.

8. The power conversion system of claim 7, wherein the full-bridge rectification circuit includes a first diode, a second diode, a third diode, and a fourth diode; a cathode of the first diode is connected to an anode of the second diode; a first node is defined between the first diode and the second diode; the first node is connected to the first input; a cathode of the third diode is connected to an anode of the fourth diode; a second node is defined between the third diode and the fourth diode; the second node is connected to the second input; a cathode of the second diode is connected to an anode of the fourth diode; a third node is defined between the second diode and the fourth diode; the third node is connected to the first output; an anode of the first diode is connected to an anode of the third diode; a fourth node is defined between the first diode and the third diode; the fourth node is connected to the second output.

9. An electronic device, comprising:
a load; and
a power conversion system, comprising:
a power distribution unit connected to an AC power source and a direct current (DC) power source, and selectively transmitting either an AC voltage of the AC power source or a first DC voltage of the DC power source based on whether the AC voltage is supplied to the power distribution unit; and a first alternating current (AC) power supply unit (PSU) connected to the power distribution unit, receiving the AC voltage or the first DC voltage based on which one of the AC voltage and the first DC voltage is outputted from the power distribution unit, and converting the AC voltage or the first DC voltage into a second DC voltage, and outputting the second DC voltage to the load.

10. The electronic device of claim 1, wherein the power distribution unit selectively outputs the AC voltage to the first AC PSU when the AC voltage is supplied to the power distribution unit, the first AC PSU correspondingly receives the AC voltage, converts the AC voltage into the second DC voltage, and outputs the second DC voltage to the load.

11. The electronic device of claim 10, wherein the power distribution unit selectively outputs the first DC voltage to the first AC PSU when the AC voltage is not supplied to the power distribution unit, the first AC PSU correspondingly receives the first DC voltage, converts the first DC voltage into the second DC voltage, and outputs the second DC voltage to the load.

12. The electronic device of claim 11, wherein the power distribution unit comprises a detection circuit and a selection circuit; the selection circuit is connected to the detection circuit, the first AC PSU, the AC power source, and the DC power source; the detection circuit detects whether the AC voltage is supplied to the selection circuit, and outputs a first control signal or a second control signal to the selection circuit based on a detection; the selection circuit selectively transmits one of the AC voltage and the first DC voltage to the first AC PSU based on which one of the first control signal and the second control signal is received from the detection circuit.

13. The electronic device of claim 12, wherein when the detection circuit detects that the AC voltage is supplied to the selection circuit, the detection circuit outputs the first control signal to the selection circuit; the selection circuit selectively transmits the AC voltage to the first AC PSU based on the first control signal; when the detection circuit detects that the AC voltage is not supplied to the selection circuit, the detection circuit outputs the second control signal to the selection circuit; the selection circuit selectively transmits the first DC voltage to the first AC PSU based on the second control signal.

14. The electronic device of claim 13, wherein the selection circuit comprises a first input, a second input, and a conductive pole; the conductive pole comprises a first end and a second end; the first input is connected to the AC power source and receives the AC voltage; the second input is connected to the DC power source and receives the first DC voltage; the first end is selectively connected to one of the first input and the second input based on which one of the first control signal and the second control signal is received from the detection circuit; the second end is connected to the first AC PSU.

15. The electronic device of claim 13, wherein the first AC PSU comprises a full-bridge rectification circuit, a resistor, and a capacitor; the full-bridge rectification circuit comprises a first input, a second input, a first output, and a second output; the resistor and the capacitor are connected between the first output and the second output in parallel; the first input is connected to the second end of the conductive pole, and receives the AC voltage or the first DC voltage; the second input is connected to ground; the first output is connected to the load; the second output is connected to ground; the full-bridge rectification circuit receives the AC voltage or the first DC voltage, converts the AC voltage or first DC voltage into the second DC voltage, and outputs the second DC voltage to the load.

16. The electronic device of claim 15, wherein the full-bridge rectification circuit includes a first diode, a second diode, a third diode, and a fourth diode; a cathode of the first diode is connected to an anode of the second diode; a first node is defined between the first diode and the second diode; the first node is connected to the first input; a cathode of the third diode is connected to an anode of the fourth diode; a second node is defined between the third diode and the fourth diode; the second node is connected to the second input; a cathode of the second diode is connected to an anode of the fourth diode; a third node is defined between the second diode and the fourth diode; the third node is connected to the first output; an anode of the first diode is connected to an anode of the third diode; a fourth node is defined between the first diode and the third diode; the fourth node is connected to the second output.
